(19) United States
(12) Patent Application Publication
(10) Pub. No.: US 2006/0290949 A1
(43) Pub. Date: Dec. 28, 2006

(54) Image forming apparatus, computer, communication system, and program

(75) Inventor: Hideki Nogawa, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/474,433

(22) Filed: Jun. 26, 2006

(30) Foreign Application Priority Data
Jun. 27, 2005 (JP) 2005-186817

(51) Int. Cl. G06F 3/12

(52) U.S. Cl. 358/1.1; 358/1.9

(57) ABSTRACT

An image forming apparatus capable of at least one of reading an image to generate image data representing the image and printing an image represented by image data is provided. The image forming apparatus comprises a detecting system to detect an error occurred in the image forming apparatus, a requesting system to request at least one external device for solution information indicating a solution to the error detected by the detecting system, an obtaining system to obtain the solution information from the at least one external device, and a display controlling system, which is adapted to display the solution information obtained by the obtaining system.

### CROSS REFERENCE TO RELATED APPLICATION

This application claims priority from Japanese Patent Application No. 2005-186817, filed on Jun. 27, 2005, the entire subject matter of which is incorporated herein by reference.

### BACKGROUND

1. Technical Field

Aspects of the invention relate to an image forming apparatus, a computer, a communication system and a program product containing instructions to operate the apparatus, the computer and the system.

2. Related Art

Conventionally, a device such as a printer, a scanner and an MFP (multifunction peripheral) to form an image, which are provided with an error diagnosis function, are known. With such an error diagnosis function, an erroneous condition or an operation failure occurred in the device can be detected and/or diagnosed.

In Japanese Patent Provisional Publication No. HEI11-314437, a printing system having a printer with an error diagnosis function, a server that transmits print information (i.e., image data to be printed) to the printer, and a host computer with a storage to store text data therein to be displayed so that a solution to deal with an error occurred in the printer is explained to a user, is disclosed.

When the erroneous condition is detected by the error diagnosis function, error information that indicates a content of the error is sent from the printer to the host computer. The host computer that receives the error information sends text data corresponding to the error indicated in the error information to the server. The server then displays sentences character strings) that represent a solution for the user to deal with the error in the printer based on the text data received from the host computer on a display device equipped to the server. The user refers to the sentences to solve the problem occurred in the printer (i.e., to execute troubleshooting and/or maintenance). Thus, the printer may not be required to have an additional volume of a storage medium to store the text data.

During such a troubleshooting operation, the user may be able to read the sentences displayed on the display device of the server if the server is located closely to the printer. However, the server may not necessarily be arranged adjacently to the printer for practical reasons, and if the server and the printer are placed in locations that are far from each other, it is inconvenient for the user to view the display of the server and executes a troubleshooting operation in the printer.

### SUMMARY OF THE INVENTION

In view of the foregoing drawbacks, aspects of the present invention are advantageous in that an image forming apparatus such as a printer, of which operational errors can be easily handled by a user, whilst a volume of a storage medium in the image forming apparatus is not necessarily increased, is provided. Another aspects of the present invention are advantageous in that a computer that communicates with such an image forming apparatus, a communication system wherein the image forming apparatus and the computer are connected, and a program product to operate the image forming apparatus, the computer, and the communication system, are provided.

### DESCRIPTION OF THE ACCOMPANYING DRAWINGS

FIG. 1 shows a block diagram to illustrate a configuration of a communication system according to an example of the invention.

FIG. 2 shows a flowchart to illustrate a priority setting process executed by a CPU of an MFP according to the example of the invention.

FIG. 3 shows a flowchart to illustrate a help information obtaining process executed by the CPU of the MFP according to the example of the invention.

FIG. 4 shows a flowchart to illustrate a help information transmitting process executed by CPUs of PCs 2a-2d according to the example of the invention.

FIG. 5 shows a diagram to illustrate a screen displayed during the priority setting according to the example of the invention.

FIG. 6A shows a screen to be displayed on an LCD (liquid crystal display) of an MFP in an prior art, and FIG. 6B shows a screen shown on an LCD according to the example of the invention.

FIG. 7A shows a screen to be displayed on an LCD of an MFP in an prior art, and FIGS. 7B-7D show screens shown on the LCD according to the example of the invention.

### DETAILED DESCRIPTION

General Overview of Aspects of the Invention

The following describes general aspects of the invention that may or may not be included in various examples and modifications. It should be noted that various connections are set forth between elements in the following description. It should be noted that these connections in general and, unless specified otherwise, may be direct or indirect and that this specification is not intended to be limiting in this respect.

According to some aspects of the invention, there is provided an image forming apparatus capable of at least one of reading an image to generate image data representing the image and forming an image represented by image data. The image forming apparatus comprises a detecting system, which is adapted to detect an error occurred in the image forming apparatus, a requesting system, which is adapted to request at least one external device for solution information indicating a solution to the error detected by the detecting system, an obtaining system, which is adapted to obtain the solution information from the at least one external device, and a display controlling system, which is adapted to display the solution information obtained by the obtaining system.

According to the above configuration, when an error occurred in the image forming apparatus, solution information that represents a solution to deal with the error is displayed on the display unit of the image forming apparatus. Therefore, a user of the image forming apparatus can refer to the solution to the error for troubleshooting, so that the error can be properly handled by the user. Further, according to the above configuration, the solution information is obtained from the external device. Therefore, additional volume of a storage device in the image forming apparatus such as a ROM (read only memory) and a HDD (hard disk drive) is not necessarily equipped to the MFP 1. Thus, cost for the additional storage device can be omitted.

In the above image forming apparatus, the obtaining system may be configured to receive the solution information sent from the external device. Alternatively, the obtaining system may be configured to access a storage unit of the external device and thereby obtain the solution information.

Optionally, a piece of the solution information may be configured to be image data.

According to the above configuration, the solution to the error can be represented in a still image and in an motion image as well as in character strings. Therefore, the solution can be informed to the user intuitively.

Optionally, the display controlling system may modify the piece of the solution information so that an entirety of the solution is displayed at a time in the display unit.

According to the above configuration, the solution information indicating the solution to the error can displayed in one screen of the display unit of the image forming apparatus, and the user is not required to switch a plurality of screens, so that the solution can be easily recognized by the user. When the solution represented in the motion image is displayed, the image may be for example shown in one screen and converted successively so that the solution is transitionally presented to the user on the screen.

Optionally, the image forming apparatus may further comprise a selecting system, which is adapted to select one external device among a plurality of the at least one external device so that the selected external device is requested by the requesting system for the solution information corresponding to the error occurred in the image forming apparatus.

According to the above configuration, the image forming apparatus is capable of selecting an external device from which the solution information corresponding to the error is obtained. Thus, the image forming apparatus can for example automatically select one of the external devices, from which the solution information is preferably obtained. In this configuration, the user can be released from a load to manually select the external device, so that the user can attain the solution in a shorter time. Further, the image forming apparatus can be configured to select an external device from which the solution information is obtained according to an input operation from the user so that the troubleshooting operation can be performed effectively to the user.

Optionally, the image forming apparatus may further comprise a setting system, which is adapted to set a priority to be complied with by the selecting system when the selecting system preferentially selects one external device among the plurality of the at least one external device.

According to the above configuration, as the selecting system selects the external device, the external device may be selected for example automatically or manually based on the input operation from the user depending on the priority set by the setting system. In such a case, the priority to be complied with the selecting system is set by the setting system.

The priority that the selecting system complies with may be set based on access frequencies from the image forming apparatus in a past period of time, and on a predetermined priority order, for example. Further, the priority may set the selecting system to select a plurality of the external devices at a time (i.e., the image forming apparatus accesses the plurality of the external devices at a time). The setting system may be configured to set a priority to be complied with the selecting system when the selecting system automatically selects the external devices.

It should be noted that the priority may be set automatically or may be set manually based on an input operation from the user. When the priority is set manually, the user may input predetermined information via an administration tool of an administration device, so that the priority to be complied with by the image forming apparatus for selecting the external devices can be set according to the information input by the user. Thus, the user can easily set the priority via the network.

According to the above configuration, as the priority that the selecting system complies with for selecting the external devices is set by the setting system, selection of the external devices is performed effectively by the selecting system, and the solution information can be obtained by the image forming apparatus easily and reliably.

According to another aspects of the invention, there is provided a computer, which is adapted to communicate with an image forming apparatus capable of at least one of reading an image to generate image data representing the image and printing an image represented by image data. The computer comprises a storage system, which is adapted to store solution information that represents a solution to handle an error occurring in the image forming apparatus, an extracting system, which is adapted to extract a piece of the solution information corresponding error information, as the error information represents an error detected in the image forming apparatus, when the computer receives the error information from the image forming apparatus, and a solution information transmitting system, which is adapted to transmit the extracted piece of the solution information to the image forming apparatus. The image forming apparatus is provided with a detecting system, which is adapted to detect the error occurred in the image forming apparatus, a requesting system, which is adapted to request the computer for the piece of the solution information corresponding to error information, an obtaining system, which is adapted to obtain the piece of the solution information transmitted from the solution information transmitting system, a display controlling system, which is adapted to display the piece of the solution information obtained by the obtaining system as the solution to handle the error in a display unit equipped to the image forming apparatus.

According to the above configuration, the computer can operate as the external device described above.

According to another aspects of the invention, there is provided a communication system comprising an image forming apparatus capable of at least one of reading an image to generate image data representing the image and printing an image represented by image data. The image forming apparatus comprises a detecting system, which is adapted to detect an error occurred in the image forming apparatus, a requesting system, which is adapted to request at least one external device storing solution information that represents a solution to handle the error occurring in the image forming apparatus for a piece of the solution information corresponding to error information, as the error information represents the error detected by the detecting system, an obtaining system, which is adapted to obtain the piece of the solution information requested by the requesting system, and a display controlling system, which is adapted to display the piece of the solution information obtained by the obtaining system as the solution to handle the error in a display unit equipped to the image forming apparatus. The communication system further comprises a computer, which is adapted to communicate with the image forming apparatus as one of the at least one external device. The computer comprises a storage system, which is adapted to store the solution information, an extracting system, which is adapted to extract the piece of the solution information corresponding the error information when the computer receives the error information from the image forming apparatus, and a solution information transmitting system, which is adapted to transmit the extracted piece of the solution information to the image forming apparatus. The obtaining system of the image forming apparatus is adapted to obtain the piece of the solution information transmitted from the solution information transmitting system of the computer.

According to the above configuration, the image forming apparatus and the computer can operate effectively in the communication system to achieve the above-described advantages.

Optionally, the requesting system of the image forming apparatus in the communication system may be adapted to transmit the error information and display capability information indicating capability of the display unit of the image forming apparatus to the computer in a process of requesting the at least one external device for the solution information. The solution information transmitting system of the computer may be adapted to modify the piece of the solution information corresponding to the error information in accordance with the capability of the display unit of the image forming apparatus and transmit the modified piece of the solution information to the image forming apparatus when the computer receives the error information and the display capability information from the image forming apparatus.

According to the above configuration, the solution information can be modified in accordance with the capability of the display unit of the image forming apparatus, and sent from the computer to the image forming apparatus. Therefore, the solution information can be properly displayed in the display unit of the image forming apparatus. It should be noted that the display capability depends on various displaying options, such as a size, a resolution, and a number of supported colors in the display unit.

Optionally, the computer may be provided with a computer-side display controlling system, which is adapted to display the modified piece of the solution information in a computer-side display unit equipped to the computer.

According to the above configuration, the computer as well as the image forming apparatus is adapted to display the solution information to indicate the solution to the error occurred in the image forming apparatus on the computer-side display unit. Therefore, the user can recognize the error has occurred in the image forming apparatus when the user is operating the computer that may or may not be located separately from the image forming apparatus, so that the user can perform a troubleshooting operation to the image forming apparatus upon the occurrence of the error.

According to another aspects of the invention, there is provided a computer program product comprising computer readable instructions adapted to cause a computer to function as a requesting system, which is adapted to request at least one external device storing solution information that represents a solution to handle an error occurring in the computer for a piece of the solution information corresponding to error information, an obtaining system, which is adapted to obtain the piece of the solution information requested by the requesting system from the at least one external device, and a display controlling system, which is adapted to display the piece of the solution information obtained by the obtaining system in a display unit equipped to the computer as the solution to handle the error detected in the computer.

According to another aspects of the invention, there is provided a computer program product comprising computer readable instructions adapted to cause a computer to function as a storage system, which is adapted to store solution information that represents a solution to handle an error occurring in an external image forming apparatus, an extracting system, which is adapted to extract a piece of the solution information corresponding error information, the error information representing an error detected in the external image forming apparatus, when the computer receives the error information from the external image forming apparatus, and a solution information transmitting system, which is adapted to transmit the extracted piece of the solution information to the external image forming apparatus.

According to the above configuration, the image forming apparatus can be effectively operated as described above.

### EXAMPLE

Hereinafter, referring to the accompanying drawings, an image forming apparatus, a computer, and a communication system according to an example of the invention will be described.

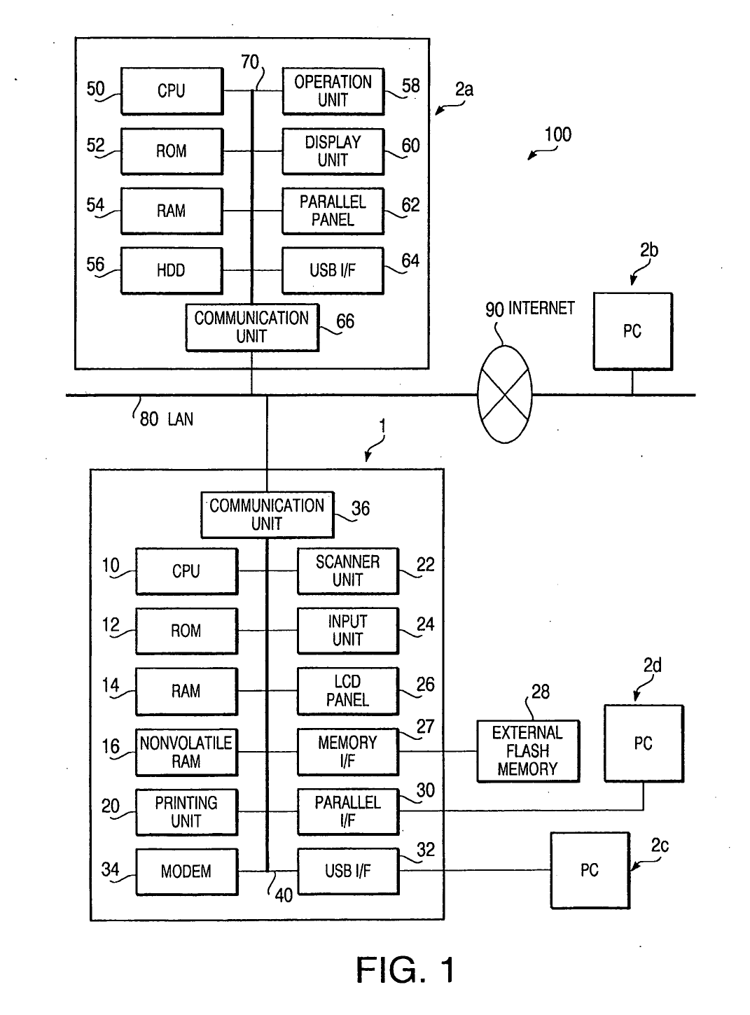

FIG. 1 shows a block diagram to illustrate a configuration of a communication system 100 comprising an MFP 1 according to an example of the invention. The communication system 100 further comprises PCs (personal computers) 2a, 2b, 2c and 2d.

The MFP 1 comprises a CPU 10, a ROM 12, a RAM 14 and a nonvolatile RAM 16, a printing unit 20, a scanner unit 22, an input unit 24, an LCD panel 26, an external flash memory 28, a memory I/F (interface) 27, a parallel I/F 30, a USB I/F 32, a modem 34, a communication unit 36 and a bus 40. The CPU 10 executes various processes that are assigned to the MFP 1. The ROM 12 stores a program (i.e., BIOS), and the like, to be executed by the CPU 10 when the MFP 1 is activated. The RAM 14 and the nonvolatile RAM 16 are used as memory areas when the CPU 10 executes the various processes. The printing unit 20 is adapted to form images, characters, and the like, on a recording medium such as a sheet of paper. The scanner unit 22 is adapted to read images, characters, and the like, provided on a recording medium. The input unit 24 comprises a plurality of operation keys (not shown), and an operation from a user is inputted through the input unit 24. The LCD 26 is adapted to display various information to be viewed by the user. The external flash memory 28 is a removable memory medium that can be removed from and attached to the MFP 1 through the memory I/F 27, and is capable of storing information therein which can be read when required. The parallel I/F 30 and the USB I/F 32 are respectively adapted to connect the MFP 1 with other external devices therethrough. The modem 34 is adapted to connect the MFP 1 with a public network, such as the Internet 90. The communication unit 36 is adapted to connect the MFP 1 with a LAN (local area network) 80 and with other networks such as the Internet 90. The bus 40 mutually connects these components in the MFP 1.

Each of the PCs 2a-2d comprises a CPU 50, a ROM 52, a RAM 54, a printing unit 20, an HDD (hard disk drive) 56, an operation unit 58, a display unit 60, a parallel I/F 62, a USB I/F 64, a communication unit 66, and a bus 70. The CPU 50 executes various processes that are assigned to each of the PCs 2a-2d. The ROM 52 stores a program (i.e., BIOS), and the like, to be executed by the CPU 50 when each of the PCs 2a-2d is activated. The RAM 54 is used as a memory area when the CPU 50 executes the various processes. The HDD 56 stores therein operating system, various programs, and the like that are executed by the CPU 50. The operation unit 58 comprises a plurality of operation keys (not shown), and an operation from the user is inputted through the operation unit 58. The display unit 60 is adapted to display various information to be viewed by the user. The parallel I/F 62 and the USB I/F 64 are respectively adapted to connect the PCs 2a-2d with other external devices therethrough. The modem 34 is adapted to connect the MFP 1 with a public network, such as the Internet 90. The communication unit 66 is adapted to connect the PCs 2a-2d with the LAN 80 and with other networks such as the Internet 90. The bus 70 mutually connects these components in each of the PCs 2a-2d.

The MFP 1 and the PC 2a are connected to the LAN 80, which is connected to the Internet 90. Further, the PC 2b is connected to the Internet 90.

The PC 2b is adapted to perform as a server, which provides functions thereof and data stored therein with the other PCs. The MFP 1 is connected with the PC 2d via the parallel I/F 30 of the MFP 1. Further, the MFP 1 is connected with the PC 2c via the USB I/F. Further, the MFP 1 is capable of communicating with each of the PCs 2c and 2d.

In the present example, a database comprising help information data, which indicates solutions to deal with an error which may occur in the MFP 1, and a service program, which is executed to use the database (which will be refereed to as a help information data service), are installed in devices (i.e., the PC 2a-2d) that are connected to the MFP 1. The errors that may occur in the MFP 1 comprise a paper jam, insufficient amount of toner and a communication failure between the above described devices, for example. The help information comprises image data that represents a figure, and the like.

When a memory medium such as a CD-ROM comprising the help information data service and a program to install the help information data service (hereinafter referred to as an install program) is inserted in a CD-ROM drive (not shown) of each of the PCs 2a-2d, each of the PCs 2a-2d reads and activates the install program, and thus the help information data service is installed in the PCs 2a-2d. It should be noted that the help information data service may be configured to be installed in the PCs 2a-2d when driver software to drive the MFP 1 is installed in the PCs 2a-2d.

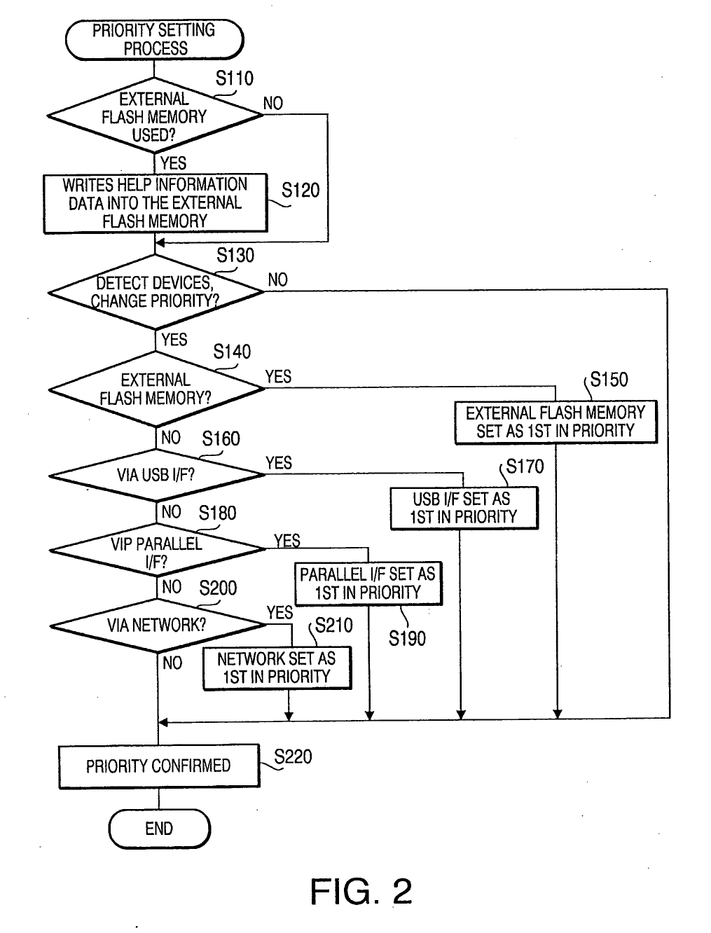

Next, referring to FIG. 2, a priority setting process, which is one of processes to be executed by the CPU 10 of the MFP 1, will be described. In the priority setting process, a priority of the devices (i.e., PCs 2a-2d), from which the MFP 1 requests the help information (i.e., attempts to access), is determined. First, in S110, the process examines whether the external flash memory 28 of the MFP 1 is to be used to store the help information data (i.e., the help information data is written into the external flash memory 28) according to an operation from the user through the input unit 24.

When the process determines that the external flash memory 28 is used as a storage for the help information data (S110: YES), the process proceeds to S120, in which the information data is written into the external flash memory 28. In this step, the MFP 1 is adapted to obtain the help information data from any one of the PCs 2a-2d that are connected to the MFP 1, and writes (copies) the help information data obtained into the external flash memory 28. The process thereafter proceeds to S130.

When the process determines that the external flash memory 28 is not to be used as the storage (S110: NO), the process directly proceeds to S130. In S110 in the present example, the usage of the external flash memory 28 is determined based on the operation from the user, however, the process may be configured to determine the usage of the external flash memory 28 by examining whether the external flash memory 28 is mounted in the memory I/F 27 of the MFP 1. That is, the process may be configured to determine to use the external flash memory 28 when the external flash memory 28 is mounted in the memory I/F 27, whilst the process determines not to use the external flash memory 28 when the external flash memory 28 is not mounted in the memory I/F 27.

In S130, the PCs 2a-2d that are connected to the MFP 1 are detected. Further, the process examines whether a priority of each of the detected PCs 2a-2d, from which the MFP 1 obtains the help information in accordance with the priority, is to de changed based on an operation inputted through the input unit 24 by the user.

In the present example, the priority of the detected PCs 2a-2d that are detected in S130 is automatically determined based on a predetermined order. The external flash memory 28 of the MFP 1 is communicably connected with the PCs 2a-2d.

In an initial setting of the present example, the PCs 2a-2d are prioritized in an order, such that the PC 2d being connected to the MFP 1 via the parallel I/F 30 is over the PC 2c being connected to the MFP 1 via the USB I/F 32, the PC 2c over the PCs 2a, 2b being connected to the MFP 1 via the network (i.e., the LAN 80 and the Internet 90), and the PCs 2a, 2b over the external flash memory 28. It should be noted that the PC 2a being connected to the MFP 1 via the LAN 80 is prioritized over the PC 2b being connected to the MFP 1 via the Internet 90. Therefore, the MPF 1 is adapted to firstly access the PC 2d, and when no help information is obtained from the PC 2d, the MFP 1 thereafter accesses the PC 2c. When no help information is obtained from the PCs 2a-2d, the MFP 1 is adapted to access the external flash memory 28 to obtain the help information therefrom.

In S130, when the process determines that the priority of the detected PCs 2a-2d is not to be changed (S130: NO), the process proceeds to S220 and confirms the priority, which is as determined in the initial setting.

It should be noted that the priority setting can be changed when the process determines in S130 the priority is to be changed based on the operation from the user. When the process determines that the priority is to be changed (S130: YES), the process proceeds to S140. In S140, the process examines whether the external flash memory 28 is temporally set as a first in the priority based on the operation from the user. When the process determines the external flash memory 28 as the first in the priority (S140: YES), the process proceeds to S150, in which the external flash memory 28 is temporally set as the first in the priority, and the process proceeds to S220.

In S220, the process confirms the priority, which is as determined in S150. Further, an order of the other detected devices (i.e., the PCs 2a-2d) in the priority is also confirmed. In the present example, the order of the other devices are determined in accordance with the initial setting. That is, a device with a higher priority in the initial setting is prioritized over the other device with a lower priority in the initial setting.

In S140, when the process determines the external flash memory 28 is not set as the first in the priority (S140: NO), the process proceeds to S160, in which the process examines whether the PC 2c being connected to the MFP 1 via the USB I/F 32 is set as a first in the priority based on the operation from the user. When the process determines that the PC 2c is set as the first in the priority (S160: YES), the process proceeds to S170, in which the PC 2c is temporally set as the first in the priority, and the process proceeds to S220.

In S220, the process confirms the priority, which is as determined in S170. Further an order of the other detected devices (i.e., the PCs 2a, 2b, 2d) and the external flash memory 28 in the priority is confirmed in accordance with the initial setting.

In S160, when the process determines the PC 2c is not set as the first in the priority (S160: NO), the process proceeds to S180, in which the process examines whether the PC 2d being connected to the MFP 1 via the parallel I/F 30 is set as a first in the priority based on the operation from the user. When the process determines that the PC 2d is set as the first in the priority (SI 80: YES), the process proceeds to S190, in which the PC 2d is temporally set as the first in the priority, and the process proceeds to S220.

In S220, the process confirms the priority, which is as determined in S190. Further an order of the other detected devices (i.e., the PCs 2c, 2d) and the external flash memory 28 in the priority is confirmed in accordance with the initial setting.

In S180, when the process determines the PC 2d is not set as the first in the priority (S180: NO), the process proceeds to S200, in which the process examines whether one of the PCs 2a, 2b being connected to the MFP 1 via the network (i.e., the LAN 80 and the Internet 90) is set as a first in the priority based on the operation from the user. When the process determines that one of the PCs 2a, 2b is set as the first in the priority (S200: YES), the process proceeds to S210, in which one of the PCs 2a, 2b is temporally set as the first in the priority. It should be noted that as the PC 2a is prioritized over the PC 2b, the PC 2a is temporally set as the first in the priority whilst the PC 2b is temporally set as a second in the priority in S210. The process thereafter proceeds to S220.

In S220, the process confirms the priority, which is as determined in S210. Further an order of the other detected devices (i.e., the PCs 2c, 2d) and the external flash memory 28 in the priority is confirmed in accordance with the initial setting.

In S200, when the process determines neither of the PCs 2a, 2b is set as the first in the priority (S200: NO), the process proceeds to S220, in which the priority is confirmed in accordance with the priority in the initial setting.

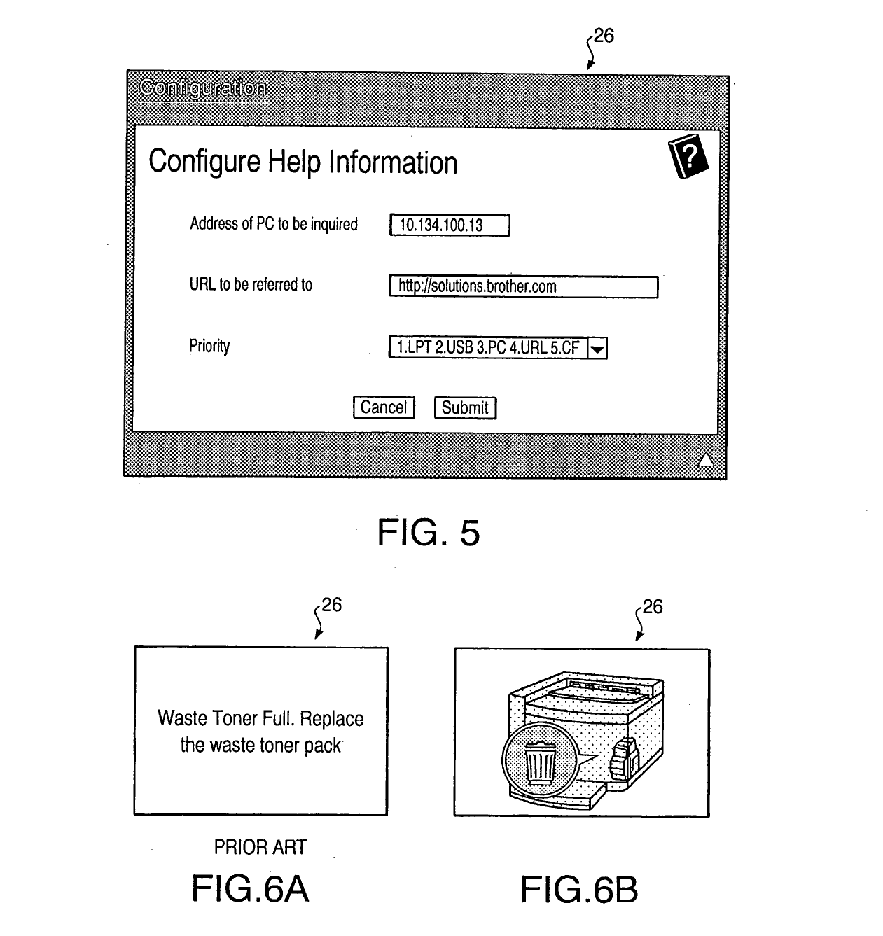

FIG. 5 shows a diagram to illustrate a screen displayed on the LCD panel 26 during the priority setting process according to the example of the invention. An item “priority” indicates the priority of the devices (the PCs 2a-2d) and the external flash memory 28 in the initial setting as described above. The user specifies the priority by selecting one of the priorities that are shown on the screen of the LCD panel 26 so that the priority of the devices (the PCs 2a-2d) and the external flash memory 28, from which the MFP 1 requests the help information is determined.

More specifically, when the user operates a button with an arrow marked thereon, a list of priority orders of the detected devices (the PCs 2a-2d) and the external flash memory 28 is displayed on the screen of the LCD panel 26. As the user selects one of the priorities, the priority is set temporarily, and when the user operates a submit button shown on the screen, the priority is confirmed. In FIG. 5, an item “Address of PC to be inquired” indicates an IP address of the PC to be referred to, which is the PC 2a in the present example , whilst an item “URL to be referred to” indicates a URL (uniform resource locator) to be referred to, which is a URL of the PC 2b in the present example.

It should be noted that the device from which the MFP 1 requests the help information may be automatically selected according to predetermined policies. In such a case, the priority of the devices may be set based on access frequencies by the MFP 1, and a device that has been requested most frequently by the MFP 1 may be specified as the highest in the priority, for example. Alternatively, the priority may be specified in a random manner. Further, more than two devices may be selected to be the highest in the priority. It should be noted that, when the device from which the MFP requests the help information is automatically selected, the MFP 1 may be configured to comply with one of the policies that specifies the priority, and the user may select the priority among the plurality of levels of priorities. In such a case, the MFP 1 may be configured to allow the user to select the priority by operating the input unit 24 of the MFP 1. Furthermore, the user may be allowed to use an administration tool installed in an administration device (not shown), which is provided in the network and input predetermined information via the administration tool, so that the priority of the devices can be configured according to the input information.

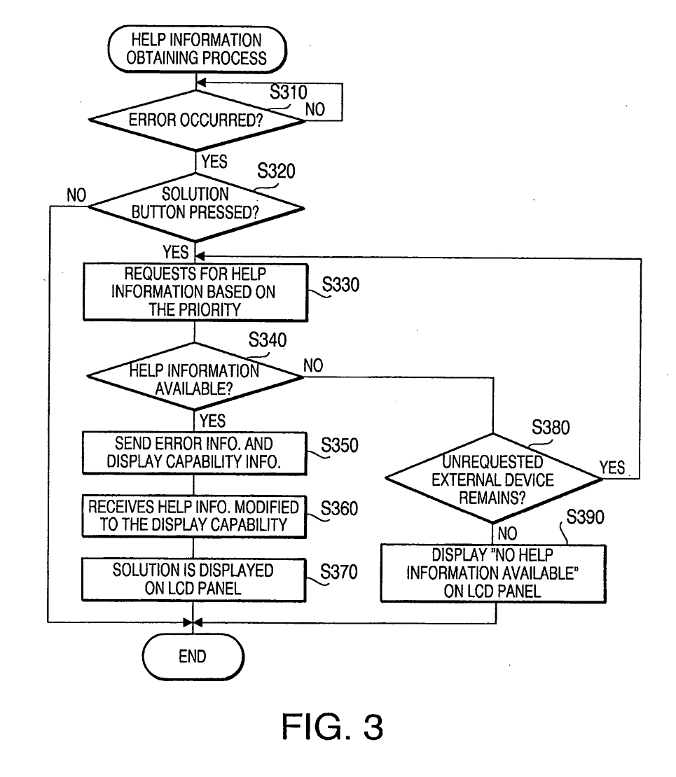

FIG. 3 shows a flowchart to illustrate a help information obtaining process executed by the CPU 10 of the MFP 1 according to the example of the invention. The help information obtaining process is a process to be executed by the MFP 1 at a predetermined interval T to obtain the help information from the other external devices (i.e., the PCs 2a-2d and the external flash memory 28).

As the help information obtaining process starts, in S310, the process examines whether an error occurred in the MFP 1. When the process determines that no error has occurred (S310: NO), the process repeats the examination process in S310.

When the process determines that an error has occurred in the MFP 1 (S310: YES), the process proceeds to S310. In S310, the process examines whether an operation from the user, for example pressing a button (not shown) for solution (hereinafter referred to as a “solution button”), is inputted. When the process determines that the solution button is not pressed (S320: NO), the process is terminated. It should be noted that, in S310, the process determines the solution button is not pressed when a predetermined period t elapses after the process determined the error had occurred in S310.

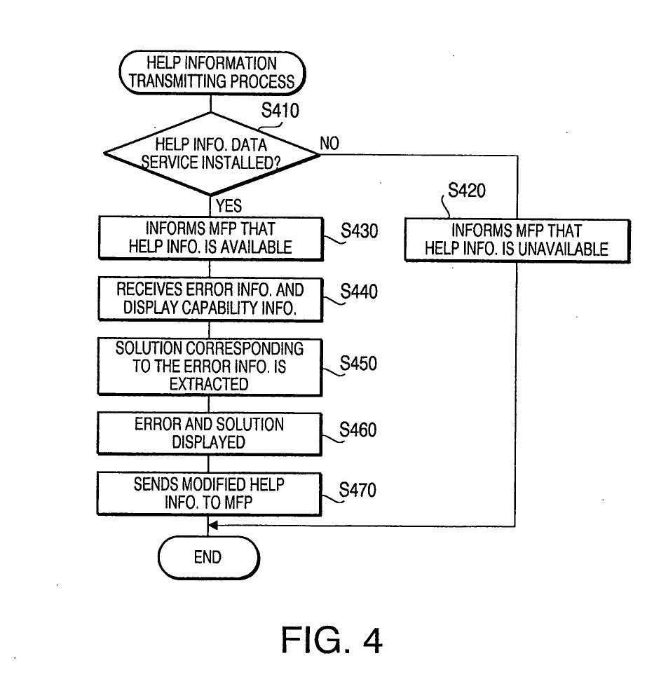

In S320, when the process determines that the solution button is pressed (S320: YES), the process proceeds to S330. In S330, the MFP 1 requests one of the devices (PCs 2a-2d, and the external flash memory 28) for the help information based on the priority set in S220 shown in FIG. 2. The process thereafter proceeds to S340, wherein the process examines whether the help information is available from the device specified in the priority. That is, the process examines whether the help information data service is installed in the specified device, and whether the help information data is stored in the device. It should be noted that the MFP 1 is adapted to receive information that indicates the help information data service is installed in the specified device (see S420 and S430 in FIG. 4) when the specified device is one of the PCs 2a-2d, so that the process determines whether the help information is available from the specified device.

In S340, when the process determines that the help information is available from the specified device (S340: YES), the process proceeds to S350. In S350, the process controls the MFP 1 to send error information that indicates the error occurred in the MFP 1 and display capability information that indicates display capability of the LCD panel 26 equipped to the MFP 1 to the specified device.

It should be noted that in S340, when the specified device is the external flash memory 28, the error information and the display capability information are merely sent (output) to a transmission buffer (not shown), in which data to be sent is temporally stored, and are not sent to the external flash memory 28.

When the specified device is one of the PCs 2a-2d, the error information and the display capability information are sent to the specified device (S350). As the specified device receives the information, the device is adapted to modify help information corresponding to the error information and the display capability information in accordance with the display capability information (see S450 in FIG. 4). The process thereafter proceeds to S360.

In S360, the process controls the MFP 1 to receive the help information modified in S350 that corresponds to the error occurred in the MFP 1. The help information is provided to the MFP 1 in S470 shown in FIG. 4, which will be described in detail hereinbelow, when the specified device is one of the PCs 2a-2d.

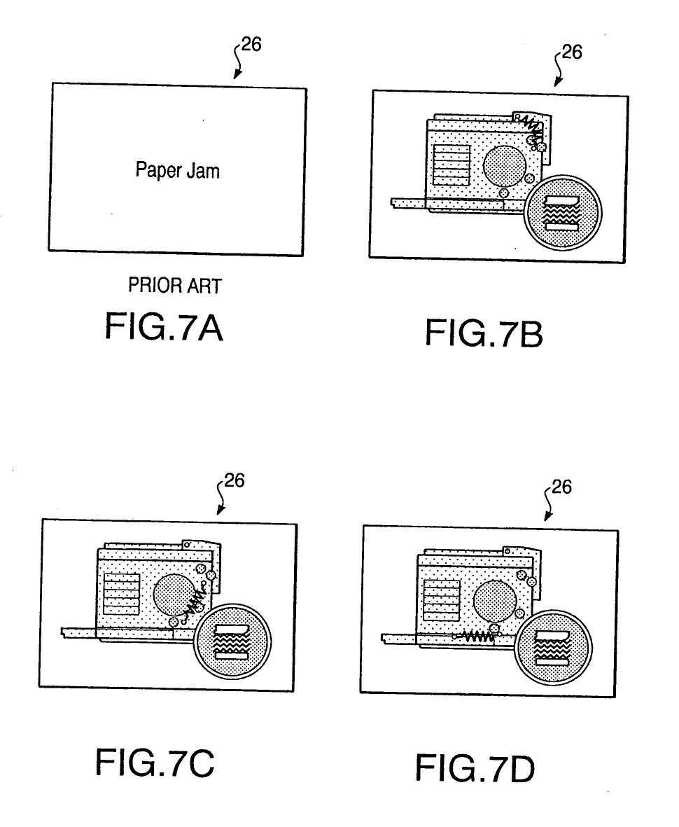

Next, the process proceeds to S370, wherein a solution represented by the help information obtained in S360 is displayed on the LCD panel 26 (see FIGS. 6B and 7B-7D).

In S340, when the process determines that the help information is not available from the specified device (S340: NO), the process proceeds to S380, wherein the process examines whether all of the devices have been requested for the help information. When the process determines that there remains a device among the devices in the priority that has not been requested for the help information (S380: YES), the process returns to S330, and requests the remaining device for the help information based on the specified priority.

When the process determines that all the devices in the priority have been requested for the help information and no device in the priority that has not been requested for the help information exists (S380: NO), the process proceeds to S390. In S390, the process controls the MFP 1 to display a message indicating no help information is available on the LCD panel 26. The process terminates thereafter.

FIG. 4 shows a flowchart to illustrate a help information transmitting process executed by the CPUs 10 of the PCs 2a-2d according to the example of the invention. The help information transmitting process is started when the MFP 1 requests for the help information in S330 shown in FIG. 3.

In the present example, the help information transmitting process executed by the CPU 10 of the PC 2a is described as an example, however, it should be noted that the process can similarly executed by the CPUs 10 of the other PCs 2b, 2c, 2d.

As the help information transmitting process starts, in S410, the process examines whether the help information data service is installed in the PC 2a. When the help information data service is not installed (S410: NO), the process proceeds to S420, wherein the process controls the PC 2a to send information indicating the help information is not available to the MFP 1. The process terminates thereafter.

In S410, when the process determines that the help information data service is installed (S410: YES), the process proceeds to S430 wherein the process sends information indicating the help information is available to the MFP 1. The process proceeds to S440.

In S440, the process controls the PC 2a to receive the error information and the display capability information sent from the MFP 1 in S350 shown in FIG. 3. The process thereafter proceeds to S450. In S450, the help information corresponding to the error information sent from the MFP 1 is extracted from the help information database. In S450, the help information extracted from the help information database is modified according to the display capability information received in S440 if necessary, so that the solution represented by the help information sent to the MFP 1 is properly displayed on the LCD panel 26. More specifically, the help information is modified so that an image representing the solution is adjusted to fit properly in a display area (not shown) of the LCD panel 26. The process proceeds to S460 thereafter.

In S460, the process controls the PC 2a to display an image that indicates the error information and an image that indicates the solution to deal with the error on the display unit 60 of the PC 2a. The process proceeds to S470 thereafter.

In S470, the help information extracted and modified in S450 to the MFP 1. The process terminates thereafter. Accordingly, the solution to the error occurred in the MFP 1 is displayed on the LCD panel 26 (in S370 shown in FIG. 3).

Next, referring to FIGS. 6B and 7A-7D, screens to be shown on the LCD panel 26 of the MFP 1 during the above-described processes according to the example of the invention will be described. As described above, the help information in the present example is configured to be image data, so that the solution to the error is displayed in an image on the screen of the LCD panel 26.

FIG. 6B illustrates a screen to be shown on the LCD panel 26 when an error occurs as an amount of toner of the MFP 1 becomes insufficient. As shown in FIG. 6B, an image that indicates a replacement of a toner pack as a solution to the error is displayed on the LCD panel 26. It should be noted that FIG. 6A illustrates a screen to be shown on an LCD panel of a conventional MFP when the amount of toner becomes insufficient and a replacement of a toner pack is required. As shown in FIG. 6A, character strings to indicate a solution to the error are displayed on the LCD.

In FIG. 6B, on the other hand, it should be noted that the solution shown on the LCD panel 26 according to the present example can be recognized by the user visually more easily compared to the character strings that are to be read by the user.

FIG. 7A illustrates a screen to be shown on an LCD panel of the conventional MFP when a sheet of paper is jammed in the MFP, whilst FIGS. 7B-7D illustrate screens to be shown on the LCD panel 26 of the MFP 1 when a sheet of paper is jammed in the MFP 1 according to the example of the present invention.

As shown in FIGS. 7B-7D, when an error occurs as the paper is jammed in the MFP 1, images to indicate the error are displayed and locations of the paper being jammed are indicated so that the user can immediately recognize the error condition and the location of the paper being jammed. Therefore, the user can remove the paper from the location by referring to the image displayed on the LCD panel 26, and the error condition is solved.

In the present example, as the image is displayed on the LCD panel 26, the PC 2a modifies the help information in accordance with the display capability of the LCD panel 26, so that the modified help information is sent to the MFP 1 to be properly displayed on the LCD panel 26 as shown in FIGS. 6B and 7B-7D. More specifically, when the display area of the LCD panel 26 is relatively small, the image indicating the help information is modified to be substantially small to fit in the display area of the LCD panel 26. When the display area of the LCD panel 26 is relatively large, the image indicating the help information is modified to be substantially large so that the user can recognize the image more easily. It should be noted that the solution displayed on the LCD panel 26 may comprise character strings in addition to the image to help the user's understanding of implication of the image.

Next, referring to FIGS. 3 and 4, a flow of communication in the communication system according to the present example will be described. In the present example, the communication between the MFP 1 and the PC 2a is described as an example, however, it should be noted that the flow of the communication can be similarly taken place in between the MFP 1 and the PCs 2b, 2c, and 2d.

When the error occurs in the MFP 1 (S310: YES), and the user presses the solution button (S320: YES), the MFP 1 requests the PC 2a for the help information corresponding to the error (S330).

As the PC 2a determines that the help information is available to the MFP 1 (S410: YES), the PC 2a notifies the MFP 1 of the availability of the help information (S430). Accordingly, as the MFP 1 determines the help information is available from the PC 2a (S340: YES), the MFP 1 sends the error information indicating the error occurred in the MPF I and the display capability information indicating the display capability of the LCD panel 26 of the MFP 1 to the PC 2a (S350).

When the PC 2a receives the error information and the display capability information from the MFP 1, the PC 2a extracts the help information indicating the solution to the error from the help information database, and modifies the help information in accordance with the display capability of the LCD panel 26 of the MFP 1 if necessary (S450). Thereafter, the PC 2a sends the help information extracted (and modified) to the MFP 1 (S470).

The MFP 1 receives the help information from the PC 2a (S360), and the MFP 1 displays the image indicating the solution to the error, such as FIGS. 6B, 7B-7D, based on the help information, on the LCD panel 26 (S370), whilst the image that indicates the error information and the image that indicates the solution to deal with the error are displayed on the display unit 60 of the PC 2a (S460).

In the above-described configuration, the user can refer to the solution to the error that occurred in the MFP 1, so that the troubleshooting operation can be performed easily. Further, as the help information is delivered from one of the external devices connected to the MFP 1 to the MFP 1 in accordance with the request from the MFP 1, storage devices of the MFP 1 such as the ROM 12 and the HDD 18 are not necessarily required to be extended to store the help information, thus cost for the additional storage device can be omitted.

Furthermore, as the solution to the error is represented in an image on the LCD panel 26 of the MFP 1, the solution can be intuitively recognized by the user.

As the PCs 2a-2d are provided with the process to modify the help information in accordance with the display capability of the LCD panel 26 of the MFP 1, the help information can be properly displayed to indicate the solution to solve the error on the LCD panel 26, which may vary in size.

According to the configuration of the MFP 1 in the present example, the MFP 1 is adapted to determine a device to request for the help information based on a predetermined priority. Therefore, the MFP 1 can obtain the help information easily and reliably from a device that is for example expected to be capable of providing the help information as the MFP 1 accesses the device prior to the other devices that are less reliable to provide the help information.

Although examples of carrying out the invention have been described, those skilled in the art will appreciate that there are numerous variations and permutations of the image output apparatus, the image output system, and the program that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

It should be noted that, for example, the MFP 1 in the present example may be replaced with a printing device and a scanner device. Further, the PCs 2a-2d as external devices may be replaced with a removable HDD and a reading unit such as a CD-ROM drive with a memory medium such as a CD-ROM comprising the help information database stored therein. It should be noted that the memory medium may be CD-ROM, DVD-ROM, and DVD-RAM, for example. In such a case, the CD-ROM drive may be replaced with a drive device that is capable of reading the recording medium.

For another example, when the image indicating the solution to the error is displayed on the LCD panel 26 of the MFP 1, a plurality of images may be simultaneously displayed. Further, a voice message in addition to an image to explain the solution may be provided to the user.

What is claimed is:

1. An image forming apparatus capable of at least one of reading an image to generate image data representing the image and forming an image represented by image data, comprising:
a detecting system, which is adapted to detect an error occurred in the image forming apparatus;
a requesting system, which is adapted to request at least one external device for solution information indicating a solution to the error detected by the detecting system;
an obtaining system, which is adapted to obtain the solution information from the at least one external device; and
a display controlling system, which is adapted to display the solution information obtained by the obtaining system.

2. The image forming apparatus according to claim 1, wherein a piece of the solution information is configured to be image data.

3. The image forming apparatus according to claim 2, wherein the display controlling system modifies the piece of the solution information so that an entirety of the solution is displayed in the display unit.

4. The image forming apparatus according to claim 1, wherein the display controlling system modifies the piece of the solution information so that an entirety of the solution is displayed in the display unit.

5. The image forming apparatus according to claim 1, further comprising a selecting system, which is adapted to select one external device among a plurality of the at least one external device so that the selected external device is requested by the requesting system for the solution information corresponding to the error occurred in the image forming apparatus.

6. The image forming apparatus according to claim 5, further comprising:
a setting system, which is adapted to set a priority to be complied with by the selecting system when the selecting system preferentially selects one external device among the plurality of the at least one external device.

7. A computer, which is adapted to communicate with an image forming apparatus capable of at least one of reading an image to generate image data representing the image and printing an image represented by image data, comprising:
a storage system, which is adapted to store solution information that represents a solution to handle an error occurring in the image forming apparatus;
an extracting system, which is adapted to extract a piece of the solution information corresponding error information, the error information representing an error detected in the image forming apparatus, when the computer receives the error information from the image forming apparatus; and
a solution information transmitting system, which is adapted to transmit the extracted piece of the solution information to the image forming apparatus,
wherein the image forming apparatus is provided with a detecting system, which is adapted to detect the error occurred in the image forming apparatus, a requesting system, which is adapted to request the computer for the piece of the solution information corresponding to error information, an obtaining system, which is adapted to obtain the piece of the solution information transmitted from the solution information transmitting system, a display controlling system, which is adapted to display the piece of the solution information obtained by the obtaining system as the solution to handle the error in a display unit equipped to the image forming apparatus.

8. The computer according to claim 7, wherein the piece of the solution information is configured to be image data.

9. The computer according to claim 8, wherein the display controlling system of the image forming apparatus modifies the piece of the solution information so that an entirety of the solution is displayed at a time in the display unit of the image forming apparatus.

10. The computer according to claim 7, wherein the display controlling system of the image forming apparatus modifies the piece of the solution information so that an entirety of the solution is displayed at a time in the display unit of the image forming apparatus.

11. The computer according to claim 7, wherein the image forming apparatus comprises a selecting system, which is adapted to select an external device among a plurality of external devices comprising the computer so that the selected external device is requested by the requesting system of the image forming apparatus for the solution information corresponding to the error occurred in the image forming apparatus.

12. The computer according to claim 11, wherein the image forming apparatus comprises a setting system, which is adapted to set a priority to be complied with by the selecting system of the image forming apparatus when the selecting system preferentially selects the external device among the plurality of external devices comprising the computer.

13. A communication system comprising:
an image forming apparatus capable of at least one of reading an image to generate image data representing the image and printing an image represented by image data, having a detecting system, which is adapted to detect an error occurred in the image forming apparatus, a requesting system, which is adapted to request at least one external device storing solution information that represents a solution to handle the error occurring in the image forming apparatus for a piece of the solution information corresponding to error information, the error information representing the error detected by the detecting system, an obtaining system, which is adapted to obtain the piece of the solution information requested by the requesting system, and a display controlling system, which is adapted to display the piece of the solution information obtained by the obtaining system as the solution to handle the error in a display unit equipped to the image forming apparatus; and
a computer, which is adapted to communicate with the image forming apparatus as one of the at least one external device, having a storage system, which is adapted to store the solution information, an extracting system, which is adapted to extract the piece of the solution information corresponding the error information when the computer receives the error information from the image forming apparatus, and a solution information transmitting system, which is adapted to transmit the extracted piece of the solution information to the image forming apparatus,
wherein the obtaining system of the image forming apparatus is adapted to obtain the piece of the solution information transmitted from the solution information transmitting system of the computer.

14. The communication system according to claim 13,
wherein the requesting system of the image forming apparatus is adapted to transmit the error information and display capability information indicating capability of the display unit of the image forming apparatus to the computer in a process of requesting the at least one external device for the solution information, and
wherein the solution information transmitting system of the computer is adapted to modify the piece of the solution information corresponding to the error information in accordance with the capability of the display unit of the image forming apparatus and transmit the modified piece of the solution information to the image forming apparatus when the computer receives the error information and the display capability information from the image forming apparatus.

15. The communication system according to claim 14,
wherein the computer is provided with a computer-side display controlling system, which is adapted to display the modified piece of the solution information in a computer-side display unit equipped to the computer.

16. The communication system according to claim 13,
wherein the computer is provided with a computer-side display controlling system, which is adapted to display the modified piece of the solution information in a computer-side display unit equipped to the computer.

17. A computer program product comprising computer readable instructions adapted to cause a computer to function as:
a requesting system, which is adapted to request at least one external device storing solution information that represents a solution to handle an error occurring in the computer for a piece of the solution information corresponding to error information;
an obtaining system, which is adapted to obtain the piece of the solution information requested by the requesting system from the at least one external device; and
a display controlling system, which is adapted to display the piece of the solution information obtained by the obtaining system in a display unit equipped to the computer as the solution to handle the error detected in the computer.

18. A computer program product comprising computer readable instructions adapted to cause a computer to function as:
a storage system, which is adapted to store solution information that represents a solution to handle an error occurring in an external image forming apparatus;
an extracting system, which is adapted to extract a piece of the solution information corresponding error information, the error information representing an error detected in the external image forming apparatus, when the computer receives the error information from the external image forming apparatus; and
a solution information transmitting system, which is adapted to transmit the extracted piece of the solution information to the external image forming apparatus.
